(19) United States
(12) Patent Application Publication
(10) Pub. No.: US 2002/0162410 A1
(43) Pub. Date: Nov. 7, 2002

(54) Telescopic linear actuator

(76) Inventor: Dean A. Zimmerman, Comstock Park, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/137,104

(22) Filed: May 2, 2002

Related U.S. Application Data
(60) Provisional application No. 60/288,593, filed on May 3, 2001.

(51) Int. Cl. F16H 27/02; F16H 3/06

(52) U.S. Cl. 74/89.35

(57) ABSTRACT

A linear actuator includes a power nut assembly and drive motor which can be secured to one end of an intermediate leg for rotating a pair of threaded shafts extending in opposite directions as the motor is actuated. One of the drive shafts is coupled to a drive tube secured to the innermost leg and extends and retracts the innermost leg from the intermediate leg. The remaining threaded drive shaft extends and retracts from the power nut assembly and is coupled to the outermost leg for extending and retracting the outermost leg with respect to the intermediate leg.

### CROSS-REFERENCE TO RELATED APPLICATIONS

This application claims priority under 35 U.S.C. §119(e) on U.S. Provisional Application No. 60/288,593 entitled INVERTED LEG TELESCOPIC LINEAR ACTUATOR, filed on May 3, 2001, by A. Dean Zimmerman, the entire disclosure of which is incorporated herein by reference.

### BACKGROUND OF THE INVENTION

The present invention relates to a compact linear actuator for use with a telescopic leg assembly.

There exists numerous telescopic leg assemblies for use in raising and lowering the heights of work surfaces, such as tables to accommodate different working conditions and projects. Typically, telescopic leg assemblies include rotatably driven, threaded screws which extend through power nuts coupled to the legs such that when a motor, which frequently is mounted externally to the legs and coupled thereto by a gear box, rotates a drive shaft in opposite directions, the rotation of the threaded screw(s) extend and retract the legs to raise and lower the work surface. Such construction, although providing some desired telescopic motion for at least two-piece legs, does not accommodate the needs for even greater height adjustment for tables nor does it provide a compact structure in view of the utilization of externally mounted drive motors which must be mounted to the undersurface of the table.

Improvements have been made in such construction, as represented by U.S. patent application Ser. No. 09/776,022 entitled MULTI LEG TELESCOPIC LINEAR ACTUATOR, filed on Feb. 2, 2001, and assigned to the present Assignee.

There remains a need, however, for an even more compact construction in which the electrical drive motor for a telescopic leg assembly can be mounted within the smallest of the telescopic legs and which is employed to control a three telescopic leg assembly for providing a compact drive mechanism for such an assembly which provides a relatively large range of adjustment.

### SUMMARY OF THE INVENTION

The system of the present invention accommodates this need by providing a power nut assembly which is secured to one end of an intermediate leg. A drive motor is coupled to the power nut assembly and a pair of threaded shafts are extended in opposite directions. One of the threaded shafts is coupled to a drive tube secured to the innermost leg and extends and retracts the innermost leg from the intermediate leg. The remaining threaded drive shaft extends and retracts from the power nut assembly and is coupled to the outermost leg for extending and retracting the outermost leg with respect to the intermediate leg. Thus, with the system of the present invention, a reversible drive motor mounted to a single power nut assembly can be secured to an end of an intermediate leg to effect movement of inner and outer legs away from and toward the intermediate leg to extend and retract a telescopic leg assembly.

With such construction, the drive motor is mounted within the innermost leg when the legs are in a contracted position to provide a compact telescopic leg assembly which provides a relatively significant scope of adjustment of, for example, a table to which said leg assembly is mounted.

These and other features, objects, and advantages of the present invention will become apparent upon reading the following description thereof together with reference to the accompanying drawings.

### BRIEF DESCRIPTION OF THE DRAWINGS

FIG. 1 is a side elevational view of a telescopic leg assembly of the present invention, shown partly in cross section and shown with the legs in an extended position;

FIG. 2 is a side elevational view of the telescopic leg assembly shown partly in cross section and shown in a retracted position;

FIG. 3 is an upper perspective view of the drive mechanism for the assembly shown in FIG. 1;

FIG. 4 is a lower perspective view of the power nut assembly, shown in assembled form;

FIG. 5 is an exploded perspective view of the power nut assembly shown in FIG. 4;

FIG. 6 is a partly exploded, perspective view of the motor mount and power nut assembly; and

FIG. 7 is a top plan view of the assembly, taken in the direction of arrow VII in FIG. 1.

### DESCRIPTION OF THE INVENTION

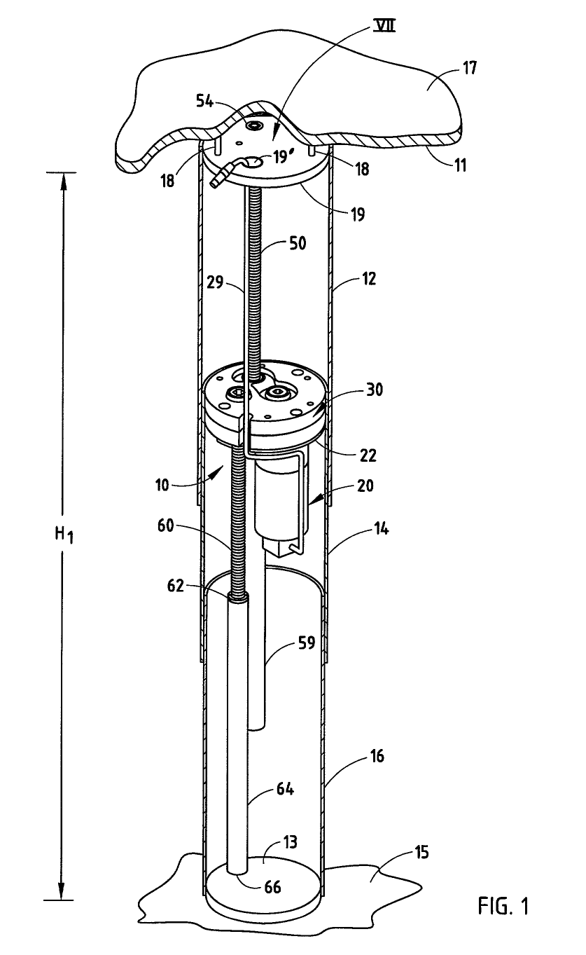

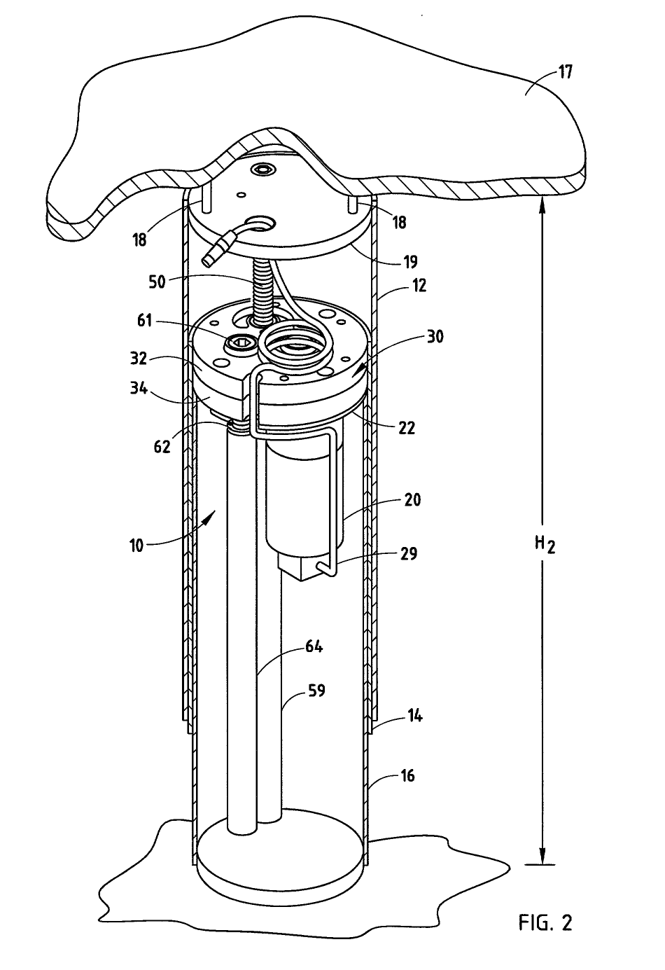

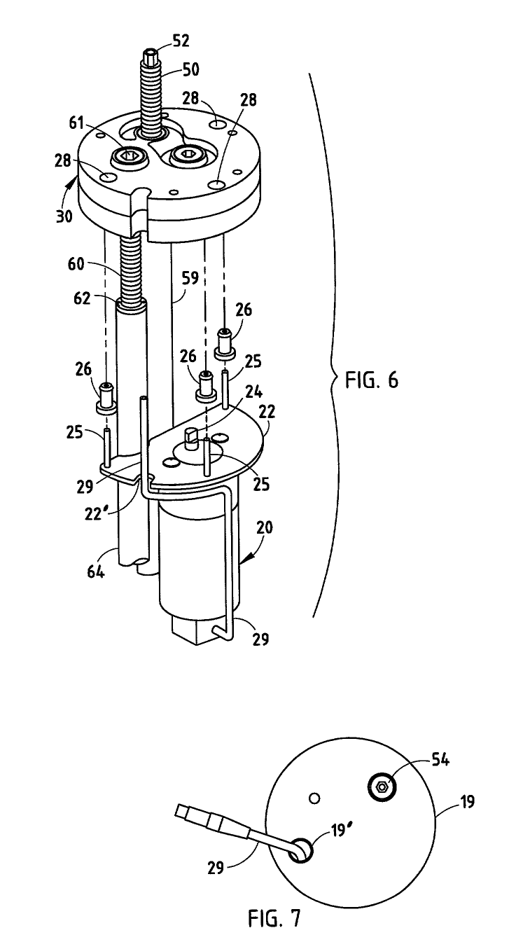

Referring initially to FIG. 1, there is shown the linear actuator system 10 of this invention, which controls the expansion and retraction of three telescopic legs. The legs include an upper outer leg 12, an intermediate leg 14, and an inner lower leg 16 which includes an internal mounting plate 13 resting on a support surface, such as floor 15. The upper end of outer leg 12 is mounted to the undersurface 11 of a work surface 17, such as a table, as seen in FIG. 1, by several mounting posts 18 which extend between upper mounting plate 19 and table 17. The linear actuator system 10, thus, expands (as shown in FIG. 1) to a first height H₁ and contracts to lower the table surface 17 to a second height H₂ (FIG. 2) upon actuation of an electrically driven reversible DC motor 20 which is mounted to a power nut assembly 30 by means of a motor mounting plate 22 (FIG. 6). The actuation of the motor can accommodate any desired intermediate heights between H₁ and H₂ by a suitable motor control circuit (no shown).

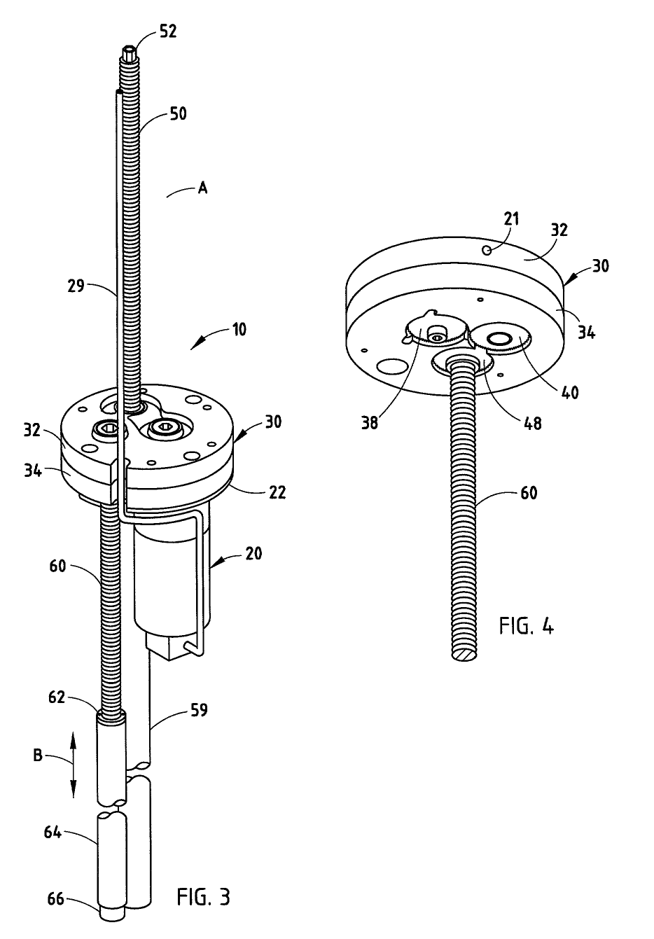

In one embodiment of the invention, the height H₁ was approximately 1235 mm, while height H₂ was approximately 535 mm. The tubular legs 12, 14, and 16, as seen in FIGS. 1 and 2, in one embodiment were cylindrical tubes, each having an outer diameter which allows the intermediate and innermost tubes to fit within one another and easily move up and down with respect to one another as seen in FIGS. 1 and 2. Other cross-sectional tubular legs, however, can be employed and driven by the linear actuator system 10 of the present invention, which is illustrated in FIG. 3.

Linear actuator 10, as best seen in FIG. 3, comprises a reversible DC motor 20 mounted to the power nut assembly 30. Movable upwardly and downwardly through the power nut assembly, as shown by arrow A in FIG. 3, is a first threaded shaft 50 having a keyed nut 52 at its upper end which is secured to upper plate 19 by a bushing 54 (FIGS. 1, 2 and 7). Threaded shaft 50 is driven by the power nut assembly 30 as described in greater detail below and, when in its downward or lowered position, extends within a cylindrical sleeve 59 mounted to the underside of power nut assembly 30 in a conventional manner to enclose the threaded shaft 50.

The upper mounting plate 19 is secured within the inner diameter of the outermost leg 12 by radially extending recessed fasteners, such as threaded screws (not shown), such that movement of threaded drive shaft 50 upwardly and downwardly moves leg 12 with respect to the intermediate leg 14 to which the disk-shaped power nut assembly 30 is secured, as seen in FIGS. 1 and 2.

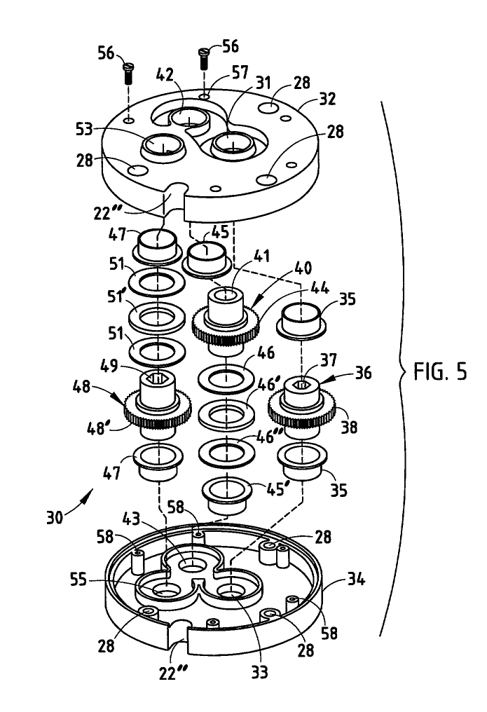

The power nut assembly 30 is also secured to the upper inner end of intermediate leg 14 by means of recessed axially extending fasteners which extend within threaded apertures 21 (FIG. 4) formed in the periphery of power nut assembly 30. Extending downwardly from power nut assembly 30 is a second threaded drive shaft 60 which does not move axially (i.e., in the direction of arrow A) with respect to power nut assembly 30 but rotates and extends into threaded engagement with a drive nut 62 secured to the upper end of drive tube 64 having its lower end 66 secured to lower plate 13, as seen in FIGS. 1 and 2. Rotation of drive shaft 60 thus causes drive tube 64 to move upwardly and downwardly with respect to power nut assembly 30 in a direction indicated by arrow B in FIG. 3. The rotation of the drive shaft 24 (FIG. 6) of drive motor 20 in opposite directions causes the upper threaded drive shaft 50 to extend away from and toward the power nut, thereby moving outer leg 12 to extend or retract with respect to the intermediate leg 14. At the same time, drive shaft 60 causes drive tube 64 mounted to the innermost leg 16 to extend and retract with respect to the intermediate leg 14. In such manner, the extension and retraction of the three telescopic legs between a fully extended position, as shown in FIG. 1, to a fully retracted position, shown in FIG. 2, is achieved. Having described the overall major components of the system and their operation, a description of the power nut assembly 30, which achieves the desired control of the telescopic legs is now presented, particularly with reference to FIG. 5.

The power nut assembly 30 comprises a two-piece, generally disk-shaped housing having an upper housing 32 and a lower housing 34 which captively and rotatably hold three intermeshing drive gears. The drive gears include a motor or first drive gear 36 having a keyed aperture 37 for receiving the drive shaft 24 (FIG. 6) of drive motor 20 for rotating motor drive gear 36. Motor drive gear 36 includes externally threaded teeth 38 which mesh with the teeth of gear 40 as described below. Upper and lower housings 32 and 34 include apertures 31 and 33, respectively, for receiving first drive gear 36 rotatably mounted therein by means of upper and lower bushings 35.

A second drive gear 40 is internally threaded at 41 to engage the threads of drive shaft 50 and is mounted within an aperture 42 in upper housing 32 by means of an upper bushing 45. The lower end of gear 40 extends through a thrust washer 46, a thrust bearing 46′ and a second thrust washer 46′ and into aperture 43 of lower housing 34 by a lower bushing 45′. Second drive gear 40 includes externally threaded teeth 44 which engage teeth 38 of the first drive gear 36 such that rotation of the first drive gear causes gear 40 to rotate, thereby causing shaft 50 to move upwardly and downwardly in a direction indicated by arrow A in FIG. 3.

Power nut assembly 30 further includes a third drive gear 48 which has a keyed aperture 49 for lockably engaging the keyed end 61 (FIG. 6) of threaded shaft 60 such that rotation of gear 48 effects rotation of shaft 60 and, therefore, the movement of drive tube 64 in a direction indicated by arrow B in FIG. 3. Gear 48 is mounted to upper and lower housings 32, 34 by means of upper and lower bushings 47 and suitable thrust washers 51 on opposite sides of thrust bearing 51′. Thus, the cylindrical ends of the drive gear 48 (like the remaining gears) are mounted by bushings 47 within cylindrical apertures 53, 55 of the upper and lower housings 32, 34, respectively. The external teeth 48′ of gear 48 mesh with the teeth of gear 40. Each of the drive gears 36, 40, and 48 are captively and rotatably mounted within the apertures 31, 33; 42, 43; and 53, 55, respectively, of the power nut housing halves 32, 34, which are held together once assembled by means of a plurality of fastening screws 56 extending through apertures 57 in the upper housing 32 and into threaded mounting bosses 58 in lower housing 34. The threading of drive gear 40 and its associated shaft 50 is selected such that rotation of motor drive gear 38 drives gear 40 in a direction such that as drive shaft 50 moves upwardly, gear 48 rotates in a direction to move drive tube 64 downwardly. Thus, rotation of the motor in one direction causes the inner and outermost legs to move away from one another while rotation of the motor drive shaft 24 in an opposite direction causes the legs 12, 16 to move toward one another to a collapsed position, as seen in FIG. 2.

As seen in FIG. 6, the motor 20 is mounted to power nut assembly 30 by means of a plurality of mounting posts 25 extending upwardly from mounting plate 22. Each of the threaded mounting posts 25 are surrounded by isolating resilient polymeric bushings 26, which extend through aligned apertures 28 in the upper and lower housing 32 and 34 of power nut assembly 30 and are secured thereto by means of threaded nuts (not shown) for anchoring the motor to the power nut assembly 30 when assembled as seen in FIG. 3. The electrical cord 29 for providing operating power to motor 20 extends through an arcuate slot 22′ in motor mounting plate 22 and correspondingly aligned slots 32″ in the upper and lower housings 32, 34 of power nut assembly 30, as best seen in FIG. 3, and is coiled in the space between power nut assembly 30 and upper plate 19, as seen in FIG. 2, when in a retracted position. The power cord extends through an aperture 19′ in upper plate 19, as seen in FIGS. 1 and 7, for connection to a suitable supply of electrical power typically extending from a control circuit for selectively adjusting the height of the table or work surface 17.

Thus, it is seen that with the drive assembly of the present invention, a single power nut assembly is employed and can be anchored to one end of one of the legs, which allows the mounting of a relatively small motor to be positioned within the innermost leg of a telescopic leg assembly to provide a significant extension and retraction of a three-piece telescopic leg assembly utilizing a relatively compact drive mechanism.

It will become apparent to those skilled in the art that various modifications to the preferred embodiment of the invention as described herein can be made without departing from the spirit or scope of the invention as defined by the appended claims.

The invention claimed is:

1. A telescopic multiple leg assembly comprising:
outer, intermediate, and inner telescopically coupled tubular legs;
a drive tube having one end coupled to one end of said inner leg and extending within said inner leg, said drive tube including a power nut at an end opposite said one end;
a power nut assembly fixedly coupled to an end of said intermediate leg and including first, second, and third drive gears having external teeth which mesh such that said first, second, and third gears rotate simultaneously, wherein said second drive gear is internally threaded;
a reversible electric drive motor coupled to said first drive gear of said power nut assembly;
a first threaded drive shaft coupled at one end to said outer leg and extending through said threaded second drive gear to extend and retract said outer leg with respect to said intermediate leg as said second drive gear rotates in opposite directions; and
a second threaded drive shaft coupled to said third drive gear and to said power nut of said drive tube to extend and retract said inner leg with respect to said intermediate leg when said drive motor is actuated in opposite directions.

2. The assembly as defined in claim 1 wherein said power nut assembly includes a housing shaped to fit within said intermediate leg and wherein said first, second, and third drive gears are rotatably mounted within said housing.

3. The assembly as defined in claim 2 wherein said housing includes two mating sections and bushings for rotatably mounting said first, second, and third drive gears in said housing.

4. The assembly as defined in claim 3 and further including a motor mounting plate to which said drive motor is secured.

5. The assembly as defined in claim 4 and further including mounting posts extending from said motor mounting plate, apertures in said housing for receiving said mounting posts and resilient bushings extending between said apertures and said posts.

6. The assembly as defined in claim 5 and further including a power cord for said drive motor and wherein said housing includes a slot for allowing said cord to extend through said slot.

7. The assembly as defined in claim 1 wherein said legs are cylindrical tubes.

8. The assembly as defined in claim 7 wherein said power nut assembly includes a disk-shaped housing secured within an upper end of said intermediate leg.

9. A drive system for a multiple leg assembly comprising:
outer, intermediate, and inner telescopically coupled legs;
a power nut assembly fixedly coupled to one end of said intermediate leg, said power nut assembly including intermeshed drive gears rotatably mounted therein;
a reversible electric drive motor positioned within said intermediate leg and coupled to at least one of said drive gears for rotating said drive gears;
a drive tube coupled to said inner leg; and
first and second threaded drive shafts engaging said drive gears, wherein said first threaded drive shaft has an end coupled to said outer leg such that rotation of said motor extends and retracts said inner and outer legs and said second drive shaft has an end coupled to a drive nut mounted to said drive tube.

10. The assembly as defined in claim 9 wherein said power nut assembly includes first, second, and third drive gears and wherein said first drive gear is coupled to said drive motor.

11. The assembly as defined in claim 10 wherein said second drive gear is internally threaded and said first drive shaft extends through said second drive gear.

12. The assembly as defined in claim 11 wherein said power nut assembly includes a housing shaped to fit within said intermediate leg and wherein said first, second, and third drive gears are rotatably mounted within said housing.

13. The assembly as defined in claim 12 wherein said housing includes two mating sections and bushings for rotatably mounting said first, second, and third drive gears in said housing.

14. The assembly as defined in claim 13 and further including a motor mounting plate to which said drive motor is secured.

15. The assembly as defined in claim 14 and further including mounting posts extending from said motor mounting plate, apertures in said housing for receiving said mounting posts and resilient bushings extending between said apertures and said posts.

16. The assembly as defined in claim 15 and further including a power cord for said drive motor and wherein said housing includes a slot for allowing said cord to extend through said slot.

17. A linear actuator for use in a telescopic multiple leg assembly comprising:
a drive tube including a power nut at one end;
a power nut assembly including first, second, and third drive gears having external teeth which mesh such that said first, second, and third gears rotate simultaneously, wherein said second drive gear is internally threaded;
a reversible electric drive motor coupled to said first drive gear of said power nut assembly;
a first threaded drive shaft extending through said threaded second drive gear to extend and retract with respect to said power nut assembly upon rotation of said second drive gear in opposite directions; and
a second threaded shaft coupled to said third drive gear and to said power nut of said drive tube to extend and retract said drive tube with respect to said power nut assembly when said drive motor is actuated in opposite directions.

18. The assembly as defined in claim 17 wherein said power nut assembly includes a housing and wherein said first, second, and third drive gears are rotatably mounted within said housing.

19. The assembly as defined in claim 18 wherein said housing includes two mating sections and bushings for rotatably mounting said first, second, and third drive gears in said housing.

20. The assembly as defined in claim 19 and further including a motor mounting plate to which said drive motor is secured.

21. The assembly as defined in claim 20 and further including mounting posts extending from said motor mounting plate, apertures in said housing for receiving said mounting posts and resilient bushings extending between said apertures and said posts.

22. The assembly as defined in claim 21 and further including a power cord for said drive motor and wherein said motor mounting plate and said housing each include a slot aligned with each other for allowing said cord to extend through said slots.
